(19) United States
(12) Patent Application Publication
(10) Pub. No.: US 2004/0142804 A1
(43) Pub. Date: Jul. 22, 2004

(54) Machine and method for producing a packet

(75) Inventors: Fiorenzo Draghetti, Bologna (IT); Stefano Bruni, San Giovanni In Persiceto (IT)

Correspondence Address: Ladas & Parry, 26 West 61 Street, New York, NY, 10023, US

(73) Assignee: G.D SOCIETA' PER AZIONI

(21) Appl. No.: 10/702,068

(22) Filed: Nov. 5, 2003

(30) Foreign Application Priority Data
Nov. 7, 2002 (IT) BO2002A000705

(51) Int. Cl. B31B 49/00

(52) U.S. Cl. 493/51

(57) ABSTRACT

A method and machine for producing a packet, whereby, as it is fed along a feed path, a substantially flat blank with preformed fold lines is extracted from the feed for transfer, crosswise to the feed path, to a stretch-folding station for stretching at least some of the fold lines, and is then fed back onto the feed path and allowed to spring back to its original flat shape.

The present invention relates to a method of producing a packet.

The present invention may be used to advantage in the packing of cigarettes, to which the following description refers purely by way of example.

### BACKGROUND OF THE INVENTION

In recent times, demand has risen for packets of cigarettes with other than sharp edges. e.g. rounded-edged packets.

A flat blank from which to produce a rounded-edged packet calls for careful processing. In particular, in view of the high operating speed of modern packing machines, portions of the blank eventually forming the rounded edges of the packet must often be stretched before the blank is folded about a group of cigarettes enclosed in foil wrapping.

For this purpose, some known packing machines comprise a linear conveyor for feeding the blank to a folding wheel; and fixed stretch-folding rails located on opposite sides of the linear conveyor to fold flaps on the blank and so stretch desired portions of the blank. At the end of the fixed rails, the blank springs back to its original substantially flat configuration, and is then fed to the folding wheel.

The stretch-folding rails are relatively bulky, and, in particular, make servicing of the conveyor awkward, fail to provide for precise stretch, and may even damage the blank due to slippage.

### SUMMARY OF THE INVENTION

It is an object of the present invention to provide a method of producing a packet, designed to eliminate the aforementioned, and which, at the same time, is cheap and easy to implement.

According to the present invention, there is provided a method of producing a packet from a blank having at least one substantially flat first portion comprising preformed fold lines; the method comprising the steps of feeding said blank along a feed path, and performing a stretching operation on at least some of said preformed fold lines; and the method being characterized in that said stretching operation is performed off said feed path by extracting said blank from a given point along said feed path, transferring the blank to a stretch-folding station in a given direction, stretching said preformed fold lines at said stretch-folding station, and restoring the stretched blank to said feed path.

To improve stretch, in the method as defined above, at least one portion of the blank is preferably wrapped about a folding spindle at said stretch-folding station, so as to define, on said portion, two second portions forming an angle of less than 90°.

The present invention also relates to a machine for producing a packet.

According to the present invention, there is provided a machine for producing a packet from a blank having at least one substantially flat portion comprising preformed fold lines; the machine comprising a conveyor for feeding the blank along a path, and a stretch-folding device for stretching at least some of said preformed fold lines at a stretch-folding station; the machine being characterized in that the stretch-folding station is located off said path, and the stretch-folding device comprises a transfer unit for transferring the blank in a given direction from a transfer station, located along the conveyor, to the stretch-folding station, and for transferring the stretched blank from the stretch-folding station to the transfer station.

### BRIEF DESCRIPTION OF THE DRAWINGS

A non-limiting embodiment of the present invention will be described by way of example with reference to the accompanying drawings, in which:

FIG. 1 shows a schematic, partly sectioned front view of a stretch-folding device of a machine for producing packets of cigarettes in accordance with the present invention;

FIG. 2 shows the FIG. 1 stretch-folding device at a successive operating step;

FIG. 3 shows a blank folding step to produce a packet of cigarettes;

FIG. 4 shows a finished packet of cigarettes.

### DETAILED DESCRIPTION OF THE INVENTION

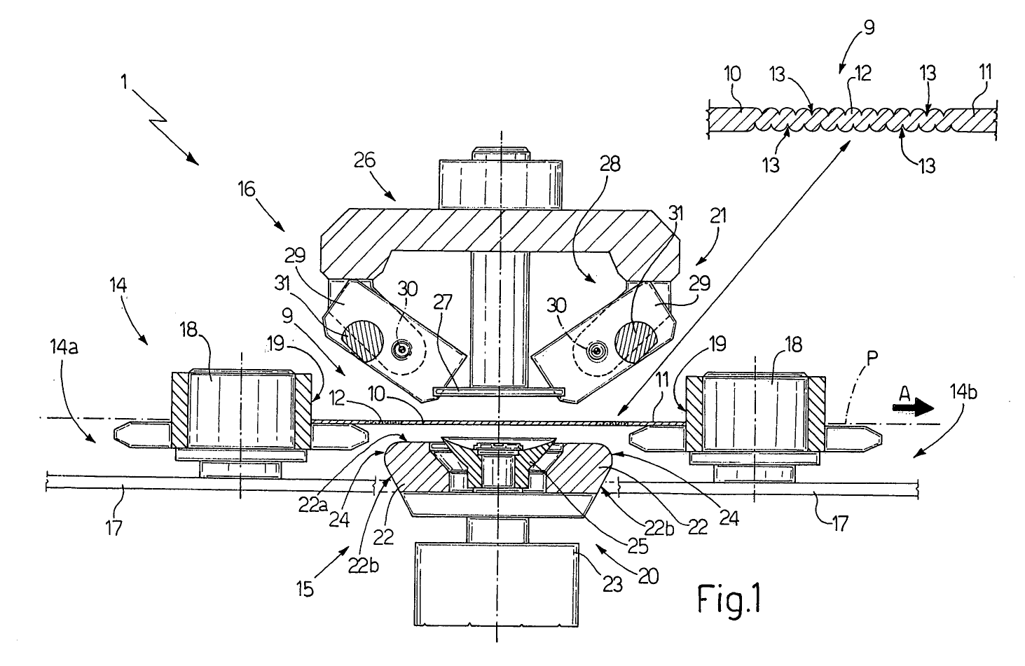

Number 1 in FIG. 1 indicates as a whole a machine for producing a rigid packet 2 of cigarettes (FIG. 4). Packet 2 comprises a cup-shaped body 3 and a lid 4 hinged to cup-shaped body 3. Cup-shaped body 3 comprises a front wall 5, two lateral walls 6 (only one shown in FIG. 4), a bottom wall 7, and a known rear wall (not shown). Lid 4 comprises a front wall 5a, two lateral walls 6a (only one shown in FIG. 4), and a known top and rear wall (not shown). Lateral walls 6 and 6a are connected to respective front walls 5 and 5a and the respective rear walls by relative rounded edges 8.

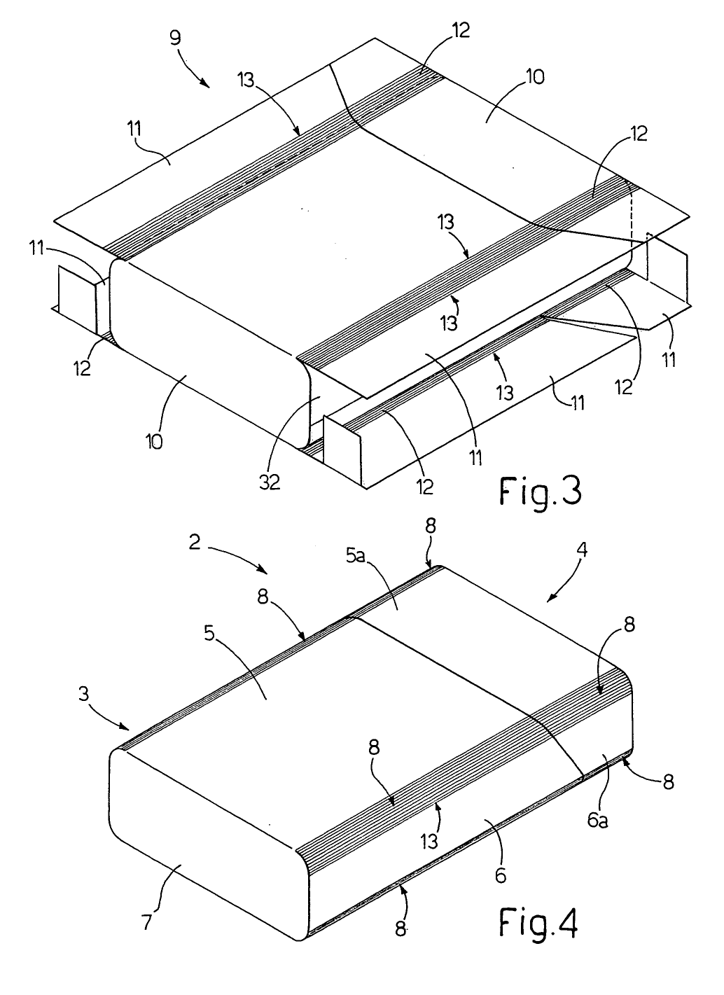

Packet 2 is formed from a substantially flat blank 9 (shown partly folded in FIG. 3) comprising a central portion 10 and a number of lateral panels 11 located symmetrically on opposite sides of portion 10. Portion 10 comprises a number of panels aligned along the longitudinal dimension of blank 9. Each panel 11 is connected to portion 10 by a respective substantially flat connecting portion 12 having preformed fold lines 13. Once folded, connecting portions 12 correspond to rounded edges 8 of packet 2.

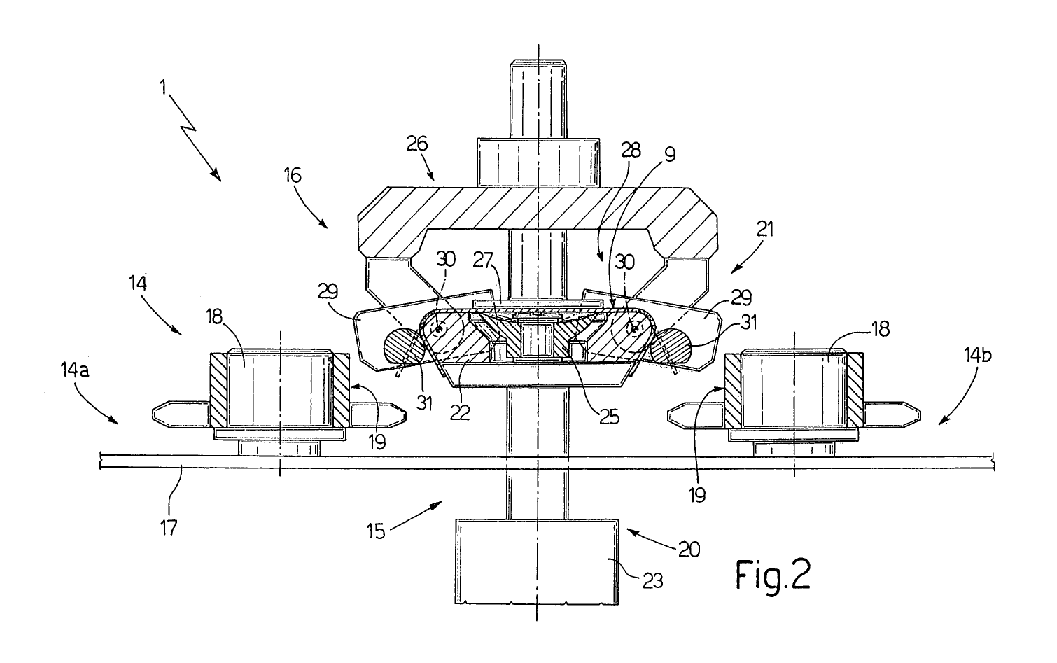

With reference to FIGS. 1 and 2, machine 1 comprises a linear step conveyor 14 for feeding blank 9 along a feed path P and through a transfer station 15 of a stretch-folding device 16. Conveyor 14 comprises two parallel belts 17 (only one shown in FIGS. 1 and 2) moving discontinuously in a substantially horizontal travelling direction A; and two clamping members 18, each connected integrally and crosswise to both belts 17. The two clamping members 18 laterally define a seat 19 for housing blank 9 in a substantially horizontal position.

Stretch-folding device 16 comprises a transfer unit 20 for transferring blank 9 from transfer station 15 to a stretch-folding station 21. Transfer unit 20 comprises a folding spindle 22; and a hydraulic actuator 23 for moving spindle 22 from transfer station 15 to stretch-folding station 21 in a substantially vertical direction crosswise to direction A. More specifically, in use, when blank 9 is located at transfer station 15 and conveyor 14 is stationary, actuator 23 lifts spindle 22 through a gap between belts 17, so that spindle 22 intercepts blank 9 and, supporting it in a horizontal position from underneath, feeds it to stretch-folding station 21.

Spindle 22 has two rounded edges 24, about which portions 12 are folded in use, and comprises a suction head 25 for securing blank 9 to spindle 22. In this connection, it should be pointed out that the relative positions and the dimensions of blank 9 and spindle 22 are such that, when blank 9 is positioned on top of spindle 22, panels 11 project, unsupported, from edges 24 of spindle 22.

Spindle 22 also has a top surface 22a, on which blank 9 rests in use; and two lateral surfaces 22b connected to the top surface by edges 24 and converging downwards.

Stretch-folding device 16 also comprises a counter-folding spindle 26 located at stretch-folding station 21 and which cooperates with spindle 22 to wrap blank 9 at least partly about spindle 22 and so stretch portions 12.

Counter-folding spindle 26 comprises a contrasting plate 27 which, as blank 9 is being folded, rests on top of blank 9 to keep it correctly positioned on top surface 22a of spindle 22.

Counter-folding spindle 26 also comprises a pocket 28, into which spindle 22 supporting blank 9 is inserted in use; and two arms 29 on opposite sides of pocket 28. Each arm 29 rotates about a respective substantially horizontal axis 30 of rotation (therefore parallel to the plane of blank 9 at stretch-folding station 21), and comprises a relative substantially cylindrical folding pin 31 which, rotating about relative axis 30, follows the contour of respective edge 24 to push relative panels 11 downwards.

In actual use, a first branch 14a of conveyor 14 feeds blank 9 to transfer station 15. As blank 9 stops at transfer station 15, hydraulic actuator 23 is activated to raise spindle 22, so that spindle 22 intercepts blank 9. As spindle 22 intercepts blank 9, suction head 25 is activated to prevent blank 9 moving with respect to spindle 22. At this point, spindle 22 lifts blank 9 into pocket 28, and, as blank 9 is being inserted inside pocket 28, pins 31 of arms 29 contact and push panels 11 down to stretch portions 12.

In this connection, it should be pointed out that, by virtue of the orientation of lateral surfaces 22b and the structure of counter-folding spindle 26, portions 12 are so folded (as shown in FIG. 2) that panels 11 rest on lateral surfaces 22b and so form, with respect to portion 10, an angle of less than 90°, which provides for effectively stretching portions 12.

Once stretching is completed, spindle 22, together with blank 9, is lowered to replace blank 9 inside seat 19 at transfer station 15. As it is being transferred back to seat 19, blank 9 springs back to its original substantially flat shape, and, once the blank is positioned inside seat 19, suction head 25 is deactivated.

At this point, belts 17 are activated, and blank 9 is fed along a second branch 14b (parallel to branch 14a) of conveyor 14 to a further known processing station not shown. Further processing steps comprise folding blank 9 about a group 32 of cigarettes (FIG. 3).

In an embodiment not shown, branches 14a and 14b of conveyor 14 are substantially crosswise to each other.

Though the above description and accompanying drawings relate to a rounded-edged packet 2 of cigarettes, the teachings of the present invention obviously also apply to any type of packet, in particular, packets of cigarettes of any type, e.g. square- or bevelled-edged hinged-lid packets, or so-called “pillow” packets, i.e. having sharp edges and one or more curved portions on the front, rear, top, bottom and/or lateral walls. Obviously, the shape of spindle 22 and counter-folding spindle 26 must be adapted to the shape of the edges to be formed.

Also, though the above description and accompanying drawings relate to stretching longitudinal edges 8 of packet 2, the teachings of the present invention obviously also apply to stretching transverse edges of a packet.

1) A method of producing a packet from a blank (9) having at least one substantially flat first portion (12) comprising preformed fold lines (13); the method comprising the steps of feeding said blank (9) along a feed path (P), and performing a stretching operation on at least some of said preformed fold lines (13); and the method being characterized in that said stretching operation is performed off said feed path (P) by extracting said blank (9) from a given point (15) along said feed path (P), transferring the blank (9) to a stretch-folding station (21) in a given direction, stretching said preformed fold lines (13) at said stretch-folding station (21), and restoring the stretched blank (9) to said feed path (P).

2) A method as claimed in claim 1, characterized in that said given direction is a direction crosswise to said feed path (P) at said given point (15).

3) A method as claimed in claim 1, characterized in that at least one portion (10, 11, 12) of the blank (9) is wrapped about a folding spindle (22) at said stretch-folding station (21), so as to define, on said portion (10, 11, 12), two second portions (10, 11) forming an angle of less than 90°.

4) A method as claimed in claim 3, characterized in that, at said stretch-folding station (21), the folding spindle (22) mates with a counter-folding spindle (26) to wrap the portion (10, 11, 12) of the blank (9) about the folding spindle (22).

5) A method as claimed in claim 3, characterized in that said portion (10, 11, 12) of the blank (9) is wrapped about the folding spindle (22) by deforming the portion (10, 11, 12) of the blank (9) by means of at least one folding member (31) movable along at least one contour of a portion (24) of an outer surface (22a, 22b, 24) of the folding spindle (22).

6) A method as claimed in claim 3, characterized in that the blank (9) is extracted from the feed path (P) and is transferred to the stretch-folding station (21) by moving the folding spindle (22) from the feed path (P) to the stretch-folding station (21).

7) A machine for producing a packet (2) from a blank (9) having at least one substantially flat portion (12) comprising preformed fold lines (13); the machine (1) comprising a conveyor (14) for feeding the blank (9) along a path (P), and a stretch-folding device (16) for stretching at least some of said preformed fold lines (13) at a stretch-folding station (21); the machine (1) being characterized in that the stretch-folding station (21) is located off said path (P), and the stretch-folding device (16) comprises a transfer unit (20) for transferring the blank (9) in a given direction from a transfer station (15), located along the conveyor (14), to the stretch-folding station (21), and for transferring the stretched blank (9) from the stretch-folding station (21) to the transfer station (15).

8) A machine as claimed in claim 7, characterized in that the conveyor (14) is substantially crosswise to said given direction.

9) A machine as claimed in claim 7, characterized in that said stretch-folding device (16) comprises a folding spindle (22), and folding means (26) for wrapping at least one portion (10, 11, 12) of the blank (9) about the folding spindle (22), so as to define, on said portion (10, 11, 12), two second portions (10, 11) forming an angle of less than 90°.

10) A machine as claimed in claim 9, characterized in that the folding means (26) comprise a counter-folding spindle (26) located at the stretch-folding station (21) and which mates with the folding spindle (22) to wrap said portion (10, 11, 12) of the blank (9) about the folding spindle (22).

11) A machine as claimed in claim 9, characterized in that the folding spindle (22) is bounded by an outer surface (22a, 22b, 24); the stretch-folding device (16) comprising at least one folding member (31) located at the stretch-folding station (21) and movable along at least one portion (24) of the outer surface (22a, 22b, 24) of the folding spindle (22) to wrap said portion (10, 11, 12) of the blank (9) about the folding spindle (22).

12) A machine as claimed in claim 11, characterized in that said folding member (31) comprises a folding pin (31) which rotates about at least one axis (30) parallel to the plane of the blank (9) at the stretch-folding station (21).

13) A machine as claimed in claim 9, characterized in that the transfer unit (20) comprises actuating means (23) for moving the folding spindle (22) from the transfer station (15) to the stretch-folding station, and from the stretch-folding station (21) to the transfer station (15); the folding spindle (22) engaging the blank (9) so that, in use, the blank (9) is transferred from the transfer station (15) to the stretch-folding station (21), and from the stretch-folding station (21) to the transfer station (15) by the movement of the folding spindle (22).

14) A machine as claimed in claim 13, characterized in that the stretch-folding device (16) comprises gripping means (25) for securing the blank (9) to the folding spindle (22).
